(19) United States
(12) Patent Application Publication
(10) Pub. No.: US 2015/0294007 A1
(43) Pub. Date: Oct. 15, 2015

(54) Performing A Search Based On Entity-Related Criteria

(71) Applicant: HEWLETT-PACKARD DEVELOPMENT COMPANY, L.P., Houston, TX (US)

(72) Inventors: Fei Chen, Palo Alto, CA (US); Xitong Liu, Palo Alto, CA (US); Hui Fang, Palo Alto, CA (US); Ke-Ke Qi, Shanghai (CN); Yue Ma, Beijing (CN); Min Wang, Palo Alto, CA (US); Xiao-Hui Huang, Shanghai (CN)

(21) Appl. No.: 14/435,809

(22) PCT Filed: Oct. 19, 2012
(86) PCT No.: PCT/US2012/061034

§ 371 Date: Apr. 15, 2015

(51) Int. Cl. G06F 17/30

(52) U.S. Cl. CPC G06F 17/30867; G06F 17/30011; G06F 17/3053; G06F 17/30604; G06F 17/30663

(57) ABSTRACT

A technique includes performing a search in response to a query that contains at least one entity term and at least one other term. The query targets a collection of structured data and unstructured data. The technique includes performing a search in the collection to find at least one document based at least in part on at least one entity mention indicated by the query.

### BACKGROUND

A typical business enterprise has a relatively large amount of information, such as emails, wikis, web pages, relational databases, and so forth, which may preferably be searched in a cost efficient manner by users of the enterprise to produce positive business outcomes. The information for the enterprise may be stored as structured data, such as data contained in relational databases, as well as unstructured data, such as data present in documents, web pages and emails.

As an example of a search, an enterprise user may submit a search query for purposes of finding a solution to a particular problem. For example, the user may be experiencing an information technology (IT)-related problem and may desire to find a self-help solution by using a query that describes the nature of the problem to search a collection of the enterprise's knowledge documents.

### BRIEF DESCRIPTION OF THE DRAWINGS

FIG. 1 is a schematic diagram of an enterprise system according to an example implementation.

FIG. 2 is an illustration of an architecture used to refine a search query to further focus the query on entity-related criteria according to an example implementation.

FIG. 3 is a flow diagram depicting a technique to refine a search query targeting a collection of structured and unstructured data based on entity-related criteria according to an example implementation.

FIG. 4 is an illustration of entity identification and mapping according to an example implementation.

FIG. 5 is an illustration of foreign key-based entity relations in structured data according to an example implementation.

FIG. 6 is an illustration of entity relations in structured data according to an example implementation.

FIG. 7 is a flow diagram depicting a technique to refine a search query to further focus the query on entity-related criteria according to an example implementation.

### DETAILED DESCRIPTION

Search queries may be used to find relevant documents in an enterprise's collection of documents. For example, an enterprise user (an employee of the enterprise, for example) may experience an information technology (IT) support problem; and in the interest of acquiring “self-help” information from the enterprise's collection of documents, the user may construct a search query and submit the query to an enterprise search engine in an attempt to retrieve relevant documents to solve the IT support problem.

As a more specific example, the user may experience the problem of not being able to access the enterprise intranet with the user's personal computer (PC); and the user may construct and submit an unstructured search query to search the enterprise's knowledge document collection, which may be, for example, a set of “how-to” documents and documents containing answers to frequently asked questions. In this context, an “unstructured query” means a query that does not have a predefined format. For example, the unstructured query may be a natural language-based query. As the user may not initially know what could be causing the problem or even which hardware/software components are related to the problem, the user, having a host computer name of “XYZ.A.com,” may submit (as an example) the following unstructured query: “XYZ cannot access intranet.”

The foregoing example search query centers around an entity, i.e., a computer called “XYZ”; and the user expects as a result of this query to retrieve relevant documents about possible causes why the users XYZ computer cannot access the enterprise intranet. However, because the enterprise's knowledge documents may seldom contain information pertaining to specific IT assets such as the “XYZ” computer, there may be many documents found containing the terms “cannot access intranet” and relatively fewer documents found containing the terms “XYZ computer.” Therefore, in a potentially complex iterative process, the user may potentially review many documents (some potentially relevant and others potentially not) that are returned in response to the query, perform a computer check to verify each possible cause, and may reformulate the query with additional knowledge gained from the first set of retrieved documents in an attempt to retrieve more relevant documents.

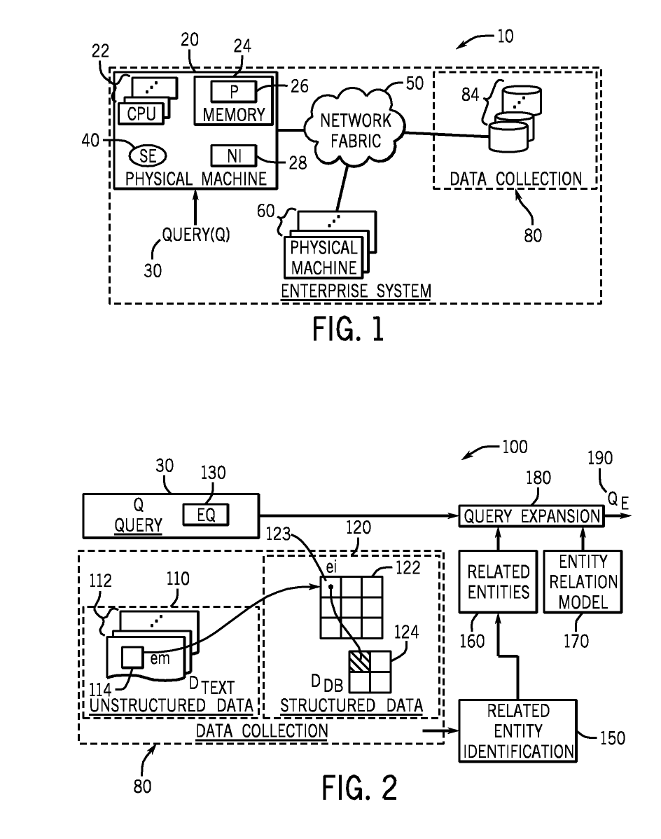

Referring to FIG. 1, in accordance with techniques and systems that are disclosed herein, for purposes of finding more relevant documents in response to an unstructured search query 30, a search engine 40 (of an enterprise system 10, for example) refines the search query 30 to further focus the query 30 on entity-related search criteria. In this manner, an “entity” refers to something tangible, which exists as a particular and discrete unit, such as (as examples) software IT assets (specific operating systems and applications for example), hardware IT assets (computers, routers, gateways, switches for example), employees, furniture, and so forth.

More specifically, techniques and systems are disclosed herein for purposes of performing entity-centric query expansion. In this manner, as further disclosed herein, the search engine 40 refines a given unstructured query 30 that targets a data collection 80 of the enterprise system 10 to effectively narrow the scope of the search in an effort to find more relevant documents based at least in part on 1: Entity(ies) that are mentioned in the search query 30; and 2. the relationships among the mentioned entity(ies) and entities that are contained in the data collection 80.

The data collection 80 contains structured and unstructured information. The unstructured information contains web pages, application-generated documents, emails, wikis, and so forth. In general, the structured information contains data arranged in specific, defined relations, such as information that is contained in tables in relational databases, for example. As described below, the unstructured information and the structured information are sources that contain rich information, which the search engine 40 exploits to improve search accuracy.

In this manner, continuing the example above in which an enterprise user searches for self-help IT information for the user's intranet connection problem, the data collection 80 may include a relational database (i.e., structured information) that contains two tables that are particularly relevant to the search query 30: an asset table containing information about the IT assets of the enterprise; and a dependency table containing information about the dependencies, or relationships, between the IT assets.

As a more specific example, the users XYZ.A.com computer may be an asset that is listed in the asset table using an “XYZ.A.com” description. The asset table may further specify that the XYZ.A.com computer has an associated identification (ID) of “A103” and is of the category “PC.” The dependency table may specify that the A103 asset is related to an asset that has an ID of “A101,” and the asset table may describe the “A101” asset as being a proxy server that has the name “proxy.A.com” for all PCs. Therefore, based on the join relations between the above-described asset and dependency tables, “proxy.A.com” is the web proxy server for all the PCs, including the users “XYZ.A.com” computer.

Continuing the example, unstructured data of the data collection 80 may be used to further augment the information gleaned from the structured information. For example, the data collection 80 may contain an unstructured data document, which contains the language, “employees need to install ActivKey” to access intranet from their PCs.” Thus, the unstructured data sets forth a relationship between “PC” and “ActivKey.”

As described herein, the search engine 40 uses the entity(ies) mentioned in the search query 30 (called “entity mentions” herein, such as “XYZ computer” for the example) along with relationships derived from entities of the structured and unstructured data (such as the above-described relationships between the PC, ActivKey and proxy.A.com entities, in the example) to further enhance the search to obtain more relevant documents. For example, using this additional information, the search engine 40 may find the following relevant documents that may be helpful in solving the user's IT problem: a first document stating, “ActivKey is required for authentication to connect to the network”; a document stating, “configure the proxy of your browser to proxy.A.com”; and an email stating, “employees cannot access intranet for 2 hours due to network failures on September 10.”

As a more specific example, in accordance with example implementations, the search engine 40 uses previously-identified related entities in the structured and unstructured data to refine a given unstructured search query 30. In this manner, the structured data contains explicit information about relations among entities, such as key-foreign key relationships. However, the entity relationship information may also be “hidden” in the unstructured data. As described herein, condition random fields models are applied to learn a domain-specific entity recognizer, and an entity recognizer is applied to documents and queries to identify entities from the unstructured information. If two entities co-occur in the same document, they are related. The relations may be discovered by the context terms surrounding their occurrences.

The search engine 40 uses the entities and relations identified in both structured and unstructured data along with a general ranking strategy to systematically integrate the entity relationships from both data types to rank the entities that have relationships with the query entity(ies). Intuitively, related entities are relevant not only to the entity(ies) mentioned in the query but are also relevant to the query as a whole. Thus, in accordance with example implementations, the ranking strategy is determined by not only the relationships between entities, but also the relevance of the related entities for the given query and the confidence of the entity identification results.

The search engine 40 uses the related entities and their relations for query refinement. In particular, depending on the particular implementation, the search engine 40 may employ one or several of the following three options to refine the query 30: 1. use related entities; 2. use relations between the related entities and query entities; and 3. use the relations between query entities.

Still referring to FIG. 1, in addition to the search engine and data collection 80, in accordance with example implementations, the enterprise system 10 includes a physical machine 20 (a laptop computer, a tablet computer, an ultrabook computer, a desktop computer, a client, a server, a smartphone and so forth), which contains the processor-based search engine 40.

For the example of FIG. 1, the data collection 80 is accessible by the physical machine 20 over network fabric 50 of the enterprise system 10. As examples, the network fabric 50 represents one of a variety of different network fabrics, such as a local area network (LAN), a wide area network (WAN), the Internet, and so forth. Moreover, in addition to the physical machine 20, the enterprise system 10 may contain one or multiple other physical machines 60.

It is noted that the physical machine 20 is an actual machine that is made up of actual hardware and software. For example, in accordance with some implementations, the physical machine 20 contains one or multiple central processing units (CPUs) 22, which individually or collectively execute machine executable instructions 26 that are stored in a memory 24 for purposes of forming the search engine 40. The memory 24 may be any non-transitory memory, such as memory formed from semiconductor devices, magnetic storage, optical storage, removable media, volatile memory, non-volatile memory, and so forth.

The physical machine 20 may contain other hardware, such as, for example, a network interface 28, user input devices, user display devices, and so forth. Moreover, although the physical machine 20 is depicted in FIG. 1 as being contained in a box, the physical machine 20 may be a distributed system, which is disposed at more than one location. Thus, many variations are contemplated, which are within the scope of the appended claims.

Turning now to more specific details, referring to FIG. 2 in conjunction with FIG. 1, in accordance with example implementations, the search engine 40 (FIG. 1) uses an architecture 100 (FIG. 2) for purposes of refining a given unstructured query 30 to expand the search criteria (i.e., more narrowly focus the scope of the search) to generate an expanded query 190 based on related entities and entity relationships. In this manner, the query 30 may contain one or multiple entity mentions 130, i.e., references to specific entities. More specifically, in accordance with example implementations, the search engine 40 performs a query expansion 180 based on 1. related entities 160, or entities that have been identified in the data collection 80 as being related to the entity mention(s) 130 and the query 30; and 2. entity relations, as set forth in an entity relation model 170.

As depicted in FIG. 2, in general, the data collection 80 is arranged in unstructured data 110 containing, for example, various documents 112 of unstructured data, which contains entity mentions 114. The entity mentions 114, in turn, may correspond to entities 123 in various tables (tables 122 and 124 being depicted in the structured data 120) of the structured data 120. Moreover, as depicted in FIG. 2, a given entity 123 in a particular table 122 of the structured data 120 may be related to another entity of another table 124 of the structured data 120 due to explicitly-defined relationships.

In the following discussion of the more specific details of the query expansion, the following notations are used. “Q” denotes an entity-centric unstructured query, such as the query 30. “E_{Q}” denotes a set of entity mentions of the query expansion in query Q. “E_{R}” denotes the related entities for query Q (such as expanded query 190. “Q_{E}” denotes the expanded query of Q (such as expanded query 190). “D” denotes an enterprise data collection (such as data collection 80). “D_{TEXT}” denotes the unstructured information in D, and “D_{DB}” denotes the structured information in D. “eᵢ” denotes an entity in the structured information D_{DB}. “eₘ” denotes an entity mention in the unstructured information D_{TEXT}. “EM(T)” denotes a set of entity mentions in the text T. “E(em)” denotes the set of top K similar candidate entities from the structured information D_{DB} for entity mention em.

In response to the query 30, the search engine 40, in general, first retrieves a set of entities E_{R} relevant to query Q. Intuitively, the relevance score of an entity is determined by the relationships between the entity and the entities in the query. The entity relationship information exists both explicitly in the structured data 120 as well as implicity in the unstructured data 110. To identify entities in the unstructured data 110, the documents 112 of the unstructured data 110 are traversed offline (examined by the search engine 40 before the particular query Q is processed, for example) for purposes of identifying whether a given document 112 contains any occurrences of entities in the structured data 120. A similar strategy may be used to identify the entity mentions E_{Q} in query Q, and then, the search engine 40 uses a ranking strategy to retrieve the related entities E_{R} for the given query Q based on the relationships between E_{R} and E_{Q}.

The related entities E_{R} are then used to estimate the entity relation model from both the structured data 120 and the unstructured data 110; and then the related entities 160 and entity relation model 170 are used to formulate the expanded query Q_{E}. Because the expanded query Q_{E} contains related entities and their relations, the retrieval performance is enhanced.

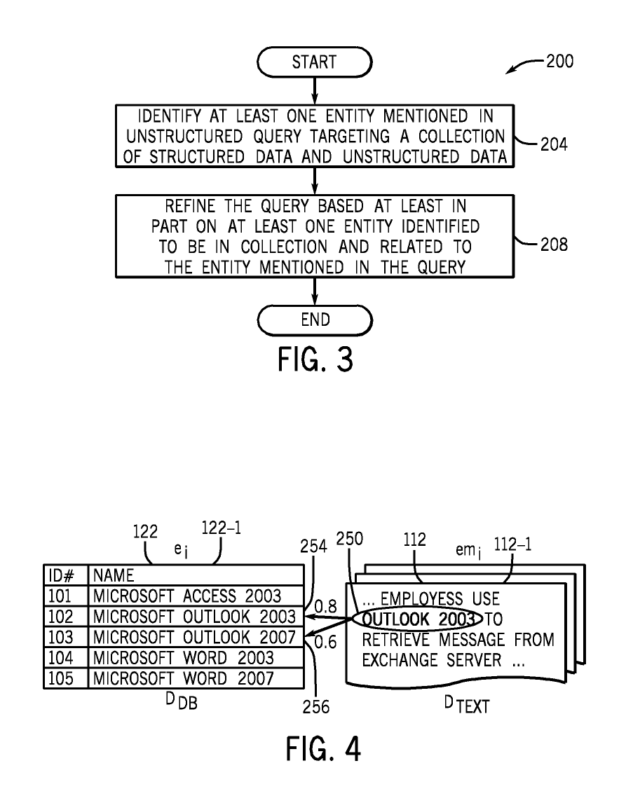

Thus, referring to FIG. 3, in accordance with an example implementation, a technique 200 includes identifying (block 204) at least one entity mentioned in an unstructured query, which targets a collection of structured data and unstructured data. The query is refined, pursuant to block 208, based at least in part on at least one entity identified to be in the collection and related to the entity mentioned in the query.

Because structured information is designed based on entity relationship models, it may be rather straightforward to identify entities and their relationships therein. However, the problem may be more challenging to identify entities and corresponding relationships in unstructured information, which does not contain information about the semantic meanings of text fragments. First discussed below is a technique to identify entities in unstructured information, and next, a general ranking strategy is discussed below to rank the entities based on the relationships in both unstructured and structured information is discussed.

Unlike structured information, unstructured information does not have semantic meanings associated with each piece of text. As a result, entities are not explicitly identified in the documents and are often represented as sequences of terms. Moreover, the mentions of an entity could have more variants in unstructured data. For example, entity “Microsoft Outlook 2003” could be mentioned as “MS Outlook 2003” in one document but as “Outlook” in another.

The majority of entities in enterprise data are domain specific entities, such as IT assets. These domain specific entities have more variations than the common types of entities. To identify entity mentions in unstructured information, a model is trained based on conditional random fields with various features including dictionary, regular expression and part of speech tags. Specifically, the model makes a binary decision for each term in a document, as the term will be labeled as either an entity term or not.

After identifying entity mentions in the unstructured data (denoted as em), the entity mentions are compared with the entities in the structured data (denoted as “e”) for purposes of make both the unstructured and structured data integrated. Specifically, a list of candidate entities from the structured data is first constructed. Given an entity mention in a document, a string similarity is determined between the entity mention and the entities on the candidate list so that the most similar candidates are selected. To minimize the impact of entity identification errors, one entity mention is mapped to multiple candidate entities, i.e., the top K candidates with the highest similarities. Each mapping between entity mention em and a candidate entity e is assigned with a mapping confidence score, i.e., c(em, e), which may be computed using, for example, the technique that is set forth in W. W. Cohen, P. Ravikumar, and S. E. Fienberg, “A COMPARISON OF STRING DISTANCE METRICS FOR NAME-MATCHING TASKS,” in IJCAI, pp. 73-78, 2003. Mapping confidence scores may be determined in alternative ways, in accordance with further implementations.

FIG. 4 is an example of potential relationships between entities contained in example structured information D_{DB} and unstructured information D_{TEXT}. As shown in FIG. 3, “ei” is a list of candidate entities constructed from the structured information D_{DB}, and “emi” is a list of entity mentions identified from the unstructured information D_{TEXT}. “Microsoft Outlook” is an entity mention, and this mention may be mapped to two entities of the structured information D_{DB} “Outlook 2003” or “Outlook 2007”. The numbers over the arrows in FIG. 4 denote the corresponding confidence scores of the entity mappings.

The next challenge performing to entity relationships relates to ranking candidate entities for a given query. The underlying assumption is that the relevance of the candidate entity for the query is determined by the relationships between the candidate entity and the entities mentioned in the query. If a candidate entity is related to more entities in the query, the entity should have a higher relevance score. Formally, the search engine 40 may determine relevance score of a candidate entity e for a query Q as follows:

$$R ( Q , e ) = {\sum }_{{em}_{i}^{Q} ∈ EM ( Q )} R ( {em}_{i}^{Q} , e ) . \qquad Eq . 1$$

Recall that, for every entity mention in the query, there may be multiple (i.e., K) possible matches from the entity candidate list, and each of matches is associated with a confidence score. The relevance score of candidate entity e for a query entity mention emᵢ^{Q} may be computed using the weighted sum of the relevance scores between e and the top K matched candidate entity of the query entity mention. Thus, Eq. 1 may be rewritten as follows:

$$R ( Q , e ) = {\sum }_{{em}_{i}^{Q} ∈ EM ( Q )} {\sum }_{{e}_{j}^{Q} ∈ E ( {em}_{j}^{Q} )} c ( {em}_{j}^{Q} , {e}_{j}^{Q} ) \cdot {R}_{e} ( {e}_{j}^{Q} , e ) , \qquad Eq . 2$$

where “E(em)” denotes the set of K candidate entities for entity mention emᵢ^{Q} in the query; “eⱼ^{Q}” denotes a matched candidate entity; “Rₑ(eⱼ^{Q}, e)” represents the relevance score between query entity eⱼ^{Q} and a candidate entity e based on their relationships in collection D; and “c(emᵢ^{Q}, eⱼ^{Q})” represents the string similarity between emᵢ^{Q} and eⱼ^{Q}.

The characteristics of both unstructured and structured information may be used to determine a relevance score between two entities, (called “Rₑ(e_{Q},e)”) based on their relationships.

More specifically, in relational databases, every table corresponds to one type of entities, and every tuple in a table corresponds to an entity. The database schema describes the relations between different tables as well as the meanings of their attributes.

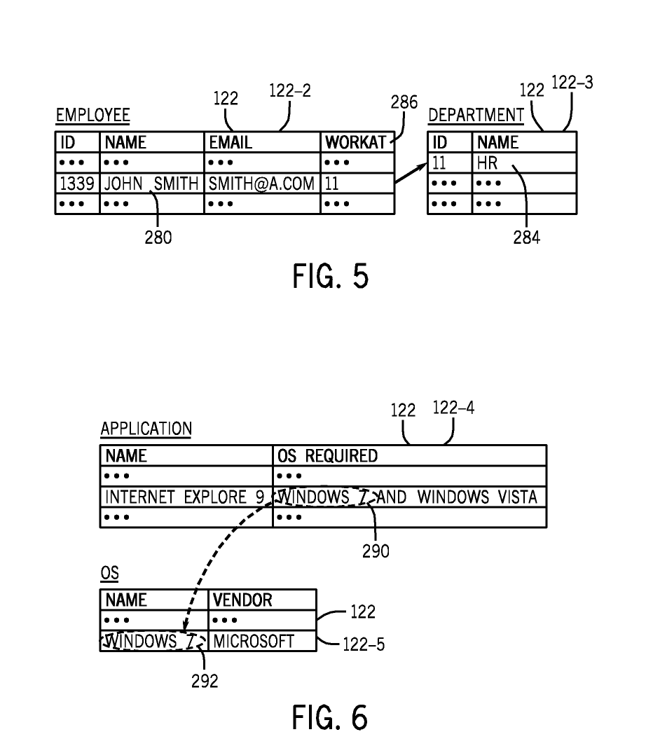

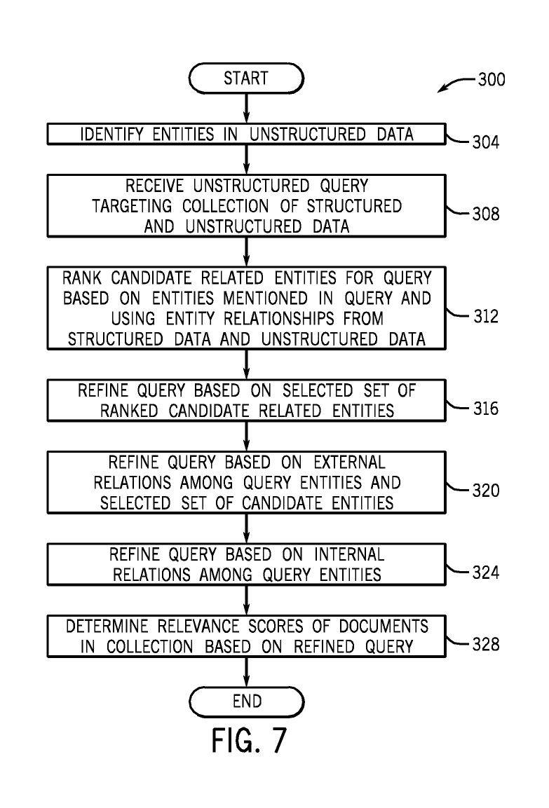

Two types of entity relationships are considered. First, if two entities are connected through foreign key links between two tables, these entities have the same relation as the one specified between the two tables. For example, as shown in the example of FIG. 5, entity “John Smith” is related to entity “HR”, and their relationship is “WorkAt.” Second, if one entity is mentioned in an attribute field of another entity, the two entities have the relation specified in the corresponding attribute name. As shown in FIG. 6, entity “Windows 7” is related to entity “Internet Explorer 9” through relation “OS Required”.

The following discusses how to compute the relevance scores between entities based on these two relation types.

The relevance scores based on foreign key relations may be computed as follows:

$${R}_{e}^{LINK} ( {e}^{Q} , e ) = \{ \begin{matrix}1 & if there is a link between {e}^{Q} and e \\ 0 & otherwise ,\end{matrix} \qquad Eq . 3$$

and the relevance scores based on field mention relations may be computed as follows:

$${R}_{e}^{FIELD} ( {e}^{Q} , e ) = {\sum }_{em ∈ EM ( {e}^{Q} \cdot text )} c ( em , e ) + {\sum }_{em ∈ EM ( e \cdot text )} c ( em , {e}^{Q} ) ,$$

where “e.text” denotes the union of text in the attribute fields of e.

The final ranking score may be determined by integrating the two types of relevance score through linear interpolation, as described below:

Rₑ^{DB}(e^{Q},e)=αR_{E}^{LINK}(e^{Q},e)+(1−α)Rₑ^{FIELD}(e^{Q},e), Eq. 5

where “α” represents a coefficient to control the influence of the two components.

Unlike in the structured data where entity relationships are specified in the database schema, there is no explicit entity relationship in unstructured data. Since the co-occurrences of entities may indicate certain semantic relations between these entities, the co-occurrence relationships may be used.

After identifying entities from unstructured data and connecting them with candidate entities as described above, the information about co-occurrences of entities in the document sets may be determined. In general, if an entity co-occurs with a query entity in more documents and the context of the co-occurrences is more relevant to the query, the entity should have higher relevance score.

Formally, the relevance score may be computed as follows:

$${R}_{e}^{TEXT} ( {e}^{Q} , e ) = {\sum }_{d ∈ {D}_{TEXT}} {{\sum }_{{em}^{Q} ∈ EM ( d )}}_{{e}^{Q} ∈ E ( {em}^{Q} )} {\sum }_{{em ∈ EM ( d )}_{e ∈ E ( em )}} \\ S ( Q , WINDOW ( {em}^{Q} , em , d ) ) \cdot c ( {em}^{Q} , {e}^{Q} ) \cdot c ( em , e ) , \qquad Eq . 6$$

where “d” denotes a document in the enterprise collection, and
“WIN DOW(em^{Q}, em, d)” represents the context of the two entities mentions in the document d. The basic assumption is that the relations between the two entities may be captured through their context. Thus, the relevance between the query and the context terms can be used to model the relevance of the relationships between two entities for the given query. The window size may be set to a predefined threshold based on preliminary results. If the distance of two entities is longer than the window size, the entities may be considered to be non-related. Note that S(Q, W/NDOW(em^{Q}, em, d)) measures the relevance score between the query and content of the two entity mentions. Because both Q and WINDOW (em^{Q}, em, d) essentially are bag of words, the relevance score between them may be estimated by existing document retrieve models.

The related entities and their relations may be utilized to improve the performance of document retrieval. Related entities, which are relevant to the query but are not directly mentioned in the query, as well as the relations between the entities, may serve as complementary information to the original query terms. Therefore, integrating the related entities and their relations into the query may aid in covering more information aspects and thus, improve the performance of document retrieval.

Language modeling may be used as framework for document retrieval. Once such retrieval model is called, “KL-divergence,” where the relevance score of document D for query Q may be estimated based on the distance between the document and query models, as described below:

$$S ( Q , D ) = - {\sum }_{w} p ( w \vert {θ}_{Q} ) log p ( w \vert {θ}_{D} ) . \qquad Eq . 7$$

To further improve the performance, the original query model may be updated using feedback documents as described below:

θ_{Q}^{new}=(1−λ)θ_{Q}+λθ_{F}, Eq. 8

where “θₚ” represents the original query model, “θ_{F}” represents the estimated feedback query model based on feedback documents, and “λ” represents a weighting factor to control the influence of the feedback model.

The query model is updated using the related entities and their relationships. More specifically, the query model may be updated as follows:

θ_{Q}^{new}=(1−λ)θ_{q}+λθ_{ER}, Eq. 9

where “θ_{Q}” represents the query model, “θ_{ER}” represents the estimated expansion model based on related entities and their relations and “λ” controls the influence of θ_{E}. Given a query Q, the relevance score of a document D may be computed as follows:

$$S ( Q , D ) = - {\sum }_{w} ( ( 1 - λ ) p ( w \vert {θ}_{Q} ) + λ p ( w \vert {θ}_{ER} ) ) log p ( w \vert {θ}_{D} ) , \qquad Eq . 10$$

where “w” represents the set of shared words between the query Q and the document D.

Disclosed below is a way, which may be used by the search engine 40 to estimate p(w|θ_{ER}) based on related entities and their relationships, in accordance with an example implementation.

The top ranked related entities E_{R} provide useful information to better reformulate the original query Q. Here a “bags-of-terms” representation is used for entity names, and a name list of related entities may be regarded as a collection of short documents. The expansion model based on the related entities may be estimated as follows:

$$p ( ( w ) \vert {θ}_{ER}^{NAME} ) = \frac{{\sum }_{{e}_{i} ∈ {E}_{R}^{L}} count ( w , N ( {e}_{i} ) )}{{\sum }_{w} , {\sum }_{{e}_{i} ∈ {E}_{R}^{L}} count ( {w}^{′} , N ( {e}_{i} ) )} , \qquad Eq . 11$$

where “E_{R}^{L}” represents the top L ranked entities from E_{R}, “N(e)” represents the name of the entity e and “w” represents a word in the vocabulary.

Although the names of related entities provide useful information, the names may be short and their effectiveness to improve retrieval performance may be relatively limited. However, the relations between entities may provide additional information that may be useful for query reformulation. For example, two relation types may be used: 1. external relations, which are the relationships between a query entity and its related entities; and 2. internal relations, which are the relationships between two query entities. For example, consider the query “XYZ cannot access intranet”, which contains one entity “XYZ”. The external relation with the related entities, e.g. “ActivKey”, would be: “ActivKey is required for authentication of XYZ to access the intranet”. Consider another query “Outlook cannot connect to Exchange Server”. For this example query, there are two entities “Outlook” and “Exchange Server”, and these entities have an internal relation, which is “Outlook retrieve email messages from Exchange Server.”

Thus, a language model is estimated based on the relations between entities. As discussed earlier, the relationship information exists as attribute names in structured data while co-occurred documents as in unstructured data. To estimate the model, the relationship information is pooled together, and maximum likelihood estimation is used to estimate the model.

Specifically, given a pair of entities, the relation information from the enterprise collection D is first determined, and then, the relation model may be estimated as follows:

p(w|θ_{ER}^{R},e₁,e₂))=p_{ML}(w|CONTENT(e₁,e₂)), Eq. 12

where “CONTENT(e₁, e₂)” represents the union of attribute names about the relationship between the entities or the set of documents mentioning both entities; and “p_{ML}” represents the maximum likelihood estimate of the document language model.

Thus, given a query Q with an E_{Q} set of query entities and “E_{R}^{L}” as a set of top L related entities, the external relation model may be estimated by taking the average over all the possible entity pairs, as set forth below:

$$p ( w \vert {θ}_{ER}^{{R}_{ex}} ) = \frac{{\sum }_{{e}_{r} ∈ {E}_{R}^{L}} {\sum }_{{e}_{q} ∈ {E}_{Q}} p ( w \vert {θ}_{ER}^{R} , {e}_{r} , {e}_{q} )}{\vert {E}_{R}^{L} \vert \cdot \vert {E}_{Q} \vert} , \qquad Eq . 13$$

where “|E_{Q}|” denotes the number of entities in the set E_{Q}. Note that |E_{R}^{L}|≦L, because some queries may have less than L related entities.

The internal relation model may be estimated as follows:

$$p ( w \vert {θ}_{ER}^{{R}_{in}} ) = \frac{{\sum }_{{e}_{1} ∈ {E}_{Q}} {\sum }_{{e}_{2} ∈ {E}_{Q} , {e}_{2} \neq {e}_{1}} p ( w \vert {θ}_{ER}^{R} , {e}_{1} , {e}_{2} )}{\frac{1}{2} \cdot \vert {E}_{Q} \vert \cdot ( \vert {E}_{Q} \vert - 1 )} , \qquad Eq . 14$$

Note that

$$\frac{1}{2} \cdot \vert {E}_{Q} \vert \cdot ( \vert {E}_{Q} \vert - 1 ) = ( \begin{matrix}\vert {E}_{Q} \vert \\ 2\end{matrix} )$$

as the co-occurrences of different entities are counted.

Referring to FIG. 6, thus, to summarize, in accordance with example implementations, a technique 300 includes identifying (block 304) entities in unstructured data and subsequently receiving (block 308) an unstructured query, which targets a collection of structured and unstructured data. The technique 300 includes ranking (block 312) candidate related entities for query based on entities mentioned in the query and using entity relationships from structure data and unstructured data. The query is refined, pursuant to block 316, based on a selected set of the ranked candidate related entities.

The technique 300 further includes refining (block 320) the query based on external relations among query entities and selective set of candidate entities. Moreover, the query may be refined, pursuant to block 324, based on internal relations among the query entities. Lastly, the relevance scores of documents in the collection may be determined, pursuant to block 328, based on the refined query.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
processing an unstructured query that contains at least one entity term and at least one term other than an entity term to identify at least one entity mention indicated by the query, the query targeting a collection of structured data and unstructured data; and
performing an entity-based search in the collection in response to the unstructured query to find at least one document, the search being based at least in part on one entity identified to be in the collection and related to the at least one entity mention.

2. The method of claim 1, wherein performing the search comprises:
for a given entity associated with the least one entity mention, identifying a ranked subset of entities of a plurality of entities identified to be in the collection; and
performing the search based at least in part on the ranked subset.

3. The method of claim 1, wherein the at least one entity mention is associated with a plurality of entities, the method further comprising:
performing the search based at least in part on at least one relationship between two entities of the plurality of entities.

4. The method of claim 1, the method further comprising:
performing the search based at least in part on at least one relationship between an entity associated with the at least one entity mention and the at least one entity identified to be in the collection.

5. The method of claim 1, wherein the at least one entity identified to be in the collection comprises at least one entity of the structured data and at least one entity of the unstructured data.

6. The method of claim 1, wherein performing the entity-based search further comprises basing the search on at least one entity relationship identified by content of an unstructured document of the collection.

7. An article comprising a non-transitory computer readable storage medium storing instructions that when executed by a computer cause the computer to:
access first information indicating at least one entity relationship within structured data of a collection of data;
access second information indicating at least one entity relationship identified by content of at least one unstructured document contained within unstructured data of the collection; and
in response to an unstructured query containing at least one entity term indicating at least one entity mention and at least one other non-entity term, perform a search in the collection to find at least one document based at least in part on the at least one entity mention, the first information and the second information.

8. The article of claim 7, the storage medium storing instructions that when executed by the computer cause the computer to:
for a given entity of the least one entity mention, identify a ranked subset of entities of a plurality of entities identified to be in the collection; and
perform the search based at least in part on the ranked subset.

9. The article of claim 7, wherein the at least one entity mention comprises a plurality of entity mentions, the storage medium storing instructions that when executed by the computer cause the computer to:
perform the search based at least in part on at least one relationship between two entities associated with the plurality of entity mentions.

10. The article of claim 7, the storage medium storing instructions that when executed by the computer cause the computer to:
perform the search based at least in part on at least one relationship between an entity associated with the at least one entity mention and at least one entity identified to be in the collection.

11. A system comprising:
a buffer to receive data indicative of an unstructured query that contains at least one entity term and at least one term other than an entity term, the query targeting a collection of structured data and unstructured data; and
a search engine comprising a processor to, in response to the query, perform an entity-based search in the collection to find at least one document, the search being based at least in part on at least one entity mention indicated by the query and at least one entity identified to be in the collection and related to the at least one entity mention.

12. The system of claim 11, wherein the processor is adapted to:
for a given entity associated with the least one entity mention, identify a ranked subset of entities of a plurality of entities identified to be in the collection; and
perform the search based at least in part on the ranked subset.

13. The system of claim 11, wherein the at least one entity mention is associated with a plurality of entities, the processor being adapted to:
perform the query based at least in part on at least one relationship between two entities of the plurality of entities.

14. The system of claim 11, wherein the processor is adapted to:
perform the query based at least in part on at least one relationship between an entity associated with the at least one entity mention and the at least one entity identified to be in the collection.

15. The system of claim 11, wherein the processor is adapted to:
receive the query; and
identify the at least one entity identified to be in the collection prior to receiving the query.
